(19) United States
(12) Patent Application Publication
(10) Pub. No.: US 2004/0260613 A1
(43) Pub. Date: Dec. 23, 2004

(54) Method and system for calculating risk components associated with the consumption of an indirect procurement commodity

(76) Inventor: Lloyd Paul Mills, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/463,994

(22) Filed: Jun. 18, 2003

(51) Int. Cl. G06F 17/60

(52) U.S. Cl. 705/26

(57) ABSTRACT

The present invention includes a method and system for calculating risk components associated with the consumption of an indirect procurement commodity. Consequently, based on the amount of risk a user is a system user willing to take, a substantial reduction in the costs associated with the purchase of indirect procurement commodities can be achieved. An aspect of the present invention is a method for calculating risk components associated with the consumption of an indirect procurement commodity. The method includes receiving consumption data related to the indirect procurement commodity, establishing a volume of the indirect procurement commodity to be consumed during a future predetermined period based on the consumption data and calculating at least one risk component wherein the at least one risk component is associated with the volume of the indirect procurement commodity to be consumed during the future predetermined duration and time period.

### FIELD OF THE INVENTION

The present invention relates generally to commodity purchasing and more particularly to a method and system for calculating risk components associated with the consumption of an indirect procurement commodity, by a commodity consumer.

### BACKGROUND OF THE INVENTION

Indirect procurement commodities are a necessary expense for almost any business venture. An indirect procurement commodity refers to any commodity or service that a company buys that does not result directly in finished goods for sale. Real estate, energy consumption, fixtures, staplers, paper, furniture, contract workers, computers and travel services are all examples of indirect procurement commodities. Indirect procurement typically accounts for over 60 percent of a company's purchasing transactions.

With regard to energy consumption, businesses have traditionally only been able to purchase energy on a full requirements contract structure. A full requirements contract is a contract in which the energy company agrees to provide all the energy to the business at a relatively high price per unit of energy consumed. The high price of the energy is based on the notion that the energy company is taking all of the risk involved in the commitment to supply all of the energy to the business. This risk is associated with the fact that the energy needs of the business tend to fluctuate and the energy company will either turn on too many generators or not enough generators. By charging businesses a relatively high price per unit of energy consumed, energy companies are assured a profit whether too many generators are turned on or not enough generators are turned on.

However, deregulation in the energy market now allows for competition between various energy generation companies and energy resellers/providers, along with ability to negotiate new contract structures. One such contract structure is called a block purchase contract. A block purchase contract is a contract in which a business agrees to purchase a certain amount of energy at an hourly rate at a specified price for a future duration. This is also known as a forward contract. The implementation of a block purchase contract allows some of the risk in the energy purchase process to be passed on to the commodity consumer. By committing to purchase a certain amount of energy at an hourly rate at specified price, the business essentially has to use that amount of energy. If the business doesn't use all of the purchased energy, money is wasted in the sense that the business has paid for energy that wasn't used. If the business uses more energy than the amount purchased, the business has to purchase energy on the open market potentially at a rate substantially higher than the negotiated block purchase rate again resulting in a waste of money for the business.

Accordingly, what is needed is a method and system that is capable of ascertaining the amount of risk that is associated with indirect procurement commodity purchases. The method and system should be simple, inexpensive and capable of being easily adapted to existing technology. The present invention addresses these needs.

### SUMMARY OF THE INVENTION

The present invention includes a method and system for calculating risk components associated with the consumption of an indirect procurement commodity. The present invention calculates risk components associated with a block purchase of the indirect procurement commodity by statistically analyzing a history of consumption of the indirect procurement commodity. Based on the calculated risk component, the indirect procurement commodity can be block purchased for a predetermined cost per unit for a specified duration and period of time. Consequently, based on the amount of risk that a user is willing to take, a substantial reduction in the costs associated with the purchase of indirect procurement commodities can be achieved.

A first aspect of the present invention is a method for calculating a risk component associated with the consumption of an indirect procurement commodity. The method includes receiving consumption data related to the indirect procurement commodity, establishing a volume of the indirect procurement commodity to be consumed during a future predetermined period based on the historical consumption data and calculating at least one risk component wherein the at least one risk component is associated with the volume of the indirect procurement commodity to be consumed during the future predetermined period.

A second aspect of the present invention is a system for calculating risk components associated with the consumption of an indirect procurement commodity. The system includes a graphical user interface, a risk calculation tool coupled to the graphical user interface wherein the risk calculation tool is capable of receiving consumption data related to the indirect procurement commodity, establishing a probable volume of the indirect procurement commodity to be consumed during a future predetermined period based on the consumption data and calculating at least one risk component wherein the at least one risk component is associated with the volume of the indirect procurement commodity to be consumed during the future predetermined period.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a high-level flow chart of a method in accordance with an embodiment of the present invention.

FIG. 2 is an illustration of a system for calculating risk components associated with the consumption of an indirect procurement commodity in accordance with an embodiment of the present invention.

FIG. 3 is a block diagram of a computer system that could be utilized in conjunction with an embodiment of the present invention.

FIG. 4 shows an example of a data matrix in accordance with an embodiment of the present invention.

FIG. 5 shows a graphical display of a mean/standard deviation table.

FIG. 6 shows a risk table in accordance with an embodiment of the present invention.

FIG. 7 is a more detailed flowchart of a method in accordance with an embodiment of the present invention.

### DETAILED DESCRIPTION

The present invention relates to a method and system for calculating risk components associated with the consumption of an indirect procurement commodity. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

As shown in the drawings for purposes of illustration, the invention is a method and system for calculating risk components associated with the consumption of an indirect procurement commodity. In an embodiment, the present invention calculates risk components associated with a block purchase of the indirect procurement commodity by statistically analyzing a history of consumption of the indirect procurement commodity. Based on the calculated risk component, the indirect procurement commodity can be block purchased for a predetermined cost per unit and duration. Consequently, based on the amount of probable risk exposure a system user is willing to take on, a substantial reduction in the costs associated with the purchase of indirect procurement commodities can be achieved.

FIG. 1 is a high level flow chart of a method in accordance with an embodiment of the present invention. A first step 110 includes receiving consumption data for a predetermined period wherein the consumption data is related to the consumption of an indirect procurement commodity. In an embodiment, the consumption data is recorded on an hourly level and the indirect procurement commodity is energy. A next step 120 includes establishing a volume of the indirect procurement commodity to be consumed during a future predetermined period based on the consumption data. A final step 130 includes calculating at least one risk component wherein the at least one risk component is associated with the volume of the indirect procurement commodity to be consumed so during a future predetermined duration. In an embodiment, risk components are calculated for a boundary of probable volume values to enable the system user to conceptualize and select a volume that corresponds to a particular risk level.

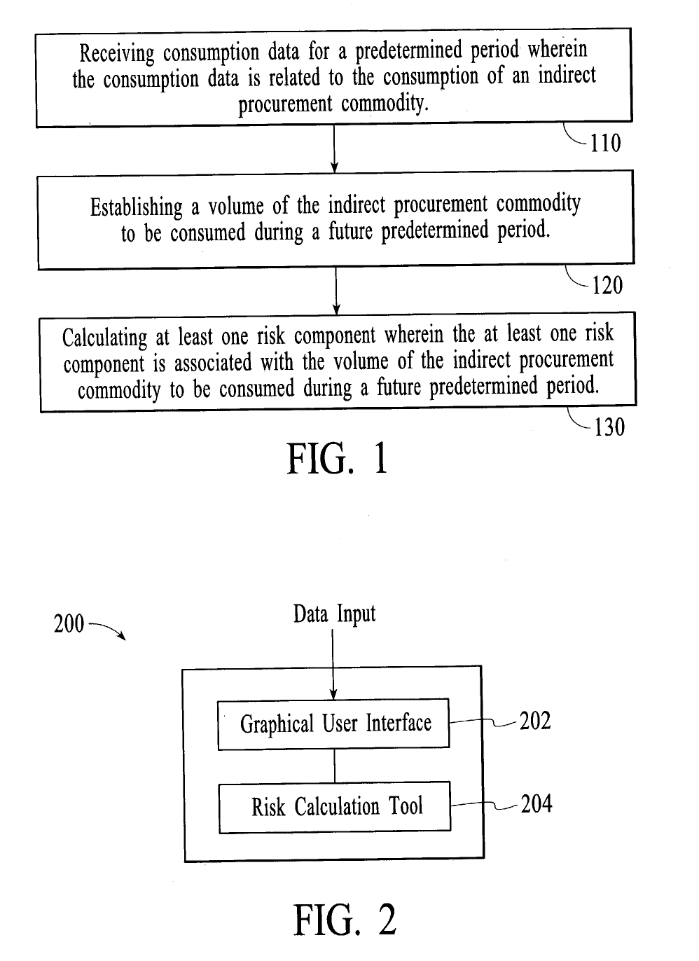

FIG. 2 is an illustration of a system 200 for calculating risk components associated with the consumption of an indirect procurement commodity in accordance with an embodiment of the present invention. System 200 includes a graphical user interface 202 and a risk calculation tool 204. A graphical user interface includes a combination of menus, screen design, keyboard commands and command language, which creates the way a user interacts with a computer. Although the above-disclosed embodiment of the present invention is described as being utilized in conjunction with a graphical user interface, one of ordinary skill in the art will readily recognize that any of a variety of user interfaces could be implemented while remaining within the spirit and scope of the present invention.

In an embodiment, the risk calculation tool 204 is Excel-based. Excel is a full-featured spreadsheet program for computer systems from Microsoft. It has the capability to link many spreadsheets for consolidation and provides a wide variety of business graphics and charts for creating presentation materials. However, one of ordinary skill in the art will readily recognize that a variety of computer programs could be utilized while remaining within the spirit and scope of the present invention. Accordingly, the risk calculation tool 204 utilizes stored statistical formulas to operate upon received commodity consumption data in order to generate a plurality of risk components of the commodity in question.

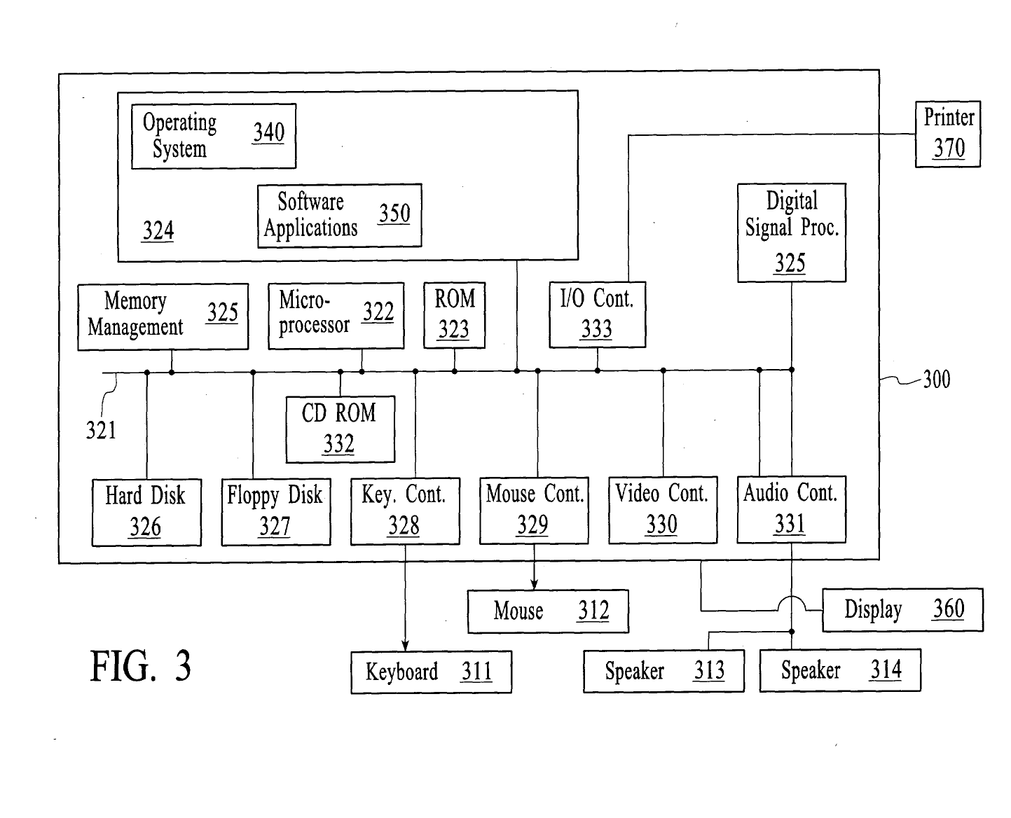

System 200 may be implemented as one or more respective software modules operating on a computer system. For an example of such a computer system, please refer to FIG. 3. In FIG. 3, a computer system 300, including, a keyboard 311, a mouse 312 and a printer 370 are depicted in block diagram form. The system 300 includes a system bus or plurality of system buses 321 to which various components are coupled and by which communication between the various components is accomplished. The microprocessor 322 is connected to the system bus 321 and is supported by read only memory (ROM) 323 and random access memory (RAM) 324 also connected to the system bus 321. A microprocessor is one of the Intel family of microprocessors including the 386, 486 or Pentium microprocessors. However, other microprocessors including, but not limited to, Motorola's family of microprocessors such as the 68000, 68020 or the 68030 microprocessors and various Reduced Instruction Set Computer (RISC) microprocessors such as the PowerPC chip manufactured by IBM. Other RISC chips made by Hewlett Packard, Sun, Motorola and others may be used in the specific computer.

The ROM 323 contains, among other code, the Basic Input-Output system (BIOS) which controls basic hardware operations such as the interaction of the processor and the disk drives and the keyboard. The RAM 324 is the main memory into which the operating system 340 and software applications 350 are loaded. The memory management chip 325 is connected to the system bus 321 and controls direct memory access operations including, passing data between the RAM 324 and hard disk drive 326 and floppy disk drive 327. The CD ROM 332 also coupled to the system bus 321 is used to store a large amount of data, e.g., a multimedia program or presentation.

Also connected to this system bus 321 are various I/O controllers: the keyboard controller 328, the mouse controller 329, the video controller 330, and the audio controller 331. As might be expected, the keyboard controller 328 provides the hardware interface for the keyboard 311, the mouse controller 329 provides the hardware interface for mouse 312, the video controller 330 is the hardware interface for the display 360, and the audio controller 331 is the hardware interface for the speakers 313, 314. Another I/O controller 333 enables communication with the printer 370.

One of ordinary skill in the art will readily recognize that the computer system 300 could comprise a personal-digital-assistant (PDA), a mobile phone, a laptop computer or a variety of other devices while remaining within the spirit and scope of the present invention.

The system 300 may also be utilized in conjunction with a distributed computing environment where tasks are performed by remote processing devices that are linked through a communications network. In a distributed computing environment, program modules may be located in both local and remote memory storage devices. Execution of the program modules may occur locally in a stand-alone manner or remotely in a client/server manner. Examples of such distributed computing environments include local area networks of an office, enterprise-wide computer networks, and the Internet. Additionally, the networks could communicate via wireless means or any of a variety of communication means while remaining within the spirit and scope of the present invention.

The above-described embodiment of the invention may also be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine readable instructions executable by a digital data processor to perform the method in accordance with an embodiment of the present invention.

This computer readable media may comprise, for example, RAM contained within the system. Alternatively, the instructions may be contained in another computer readable media such as a magnetic data storage diskette and directly or indirectly accessed by the computer system. Whether contained in the computer system or elsewhere, the instructions may be stored on a variety of machine readable storage media, such as a DASD storage (for example, a conventional “hard drive” or a RAID array), magnetic tape, electronic read-only memory, an optical storage device (for example, CD ROM, WORM, DVD, digital optical tape), paper “punch” cards, or other suitable computer readable media including transmission media such as digital, analog, and wireless communication links. In an illustrative embodiment of the invention, the machine-readable instructions may comprise lines of compiled C, C++, or similar language code commonly used by those skilled in the programming for this type of application arts.

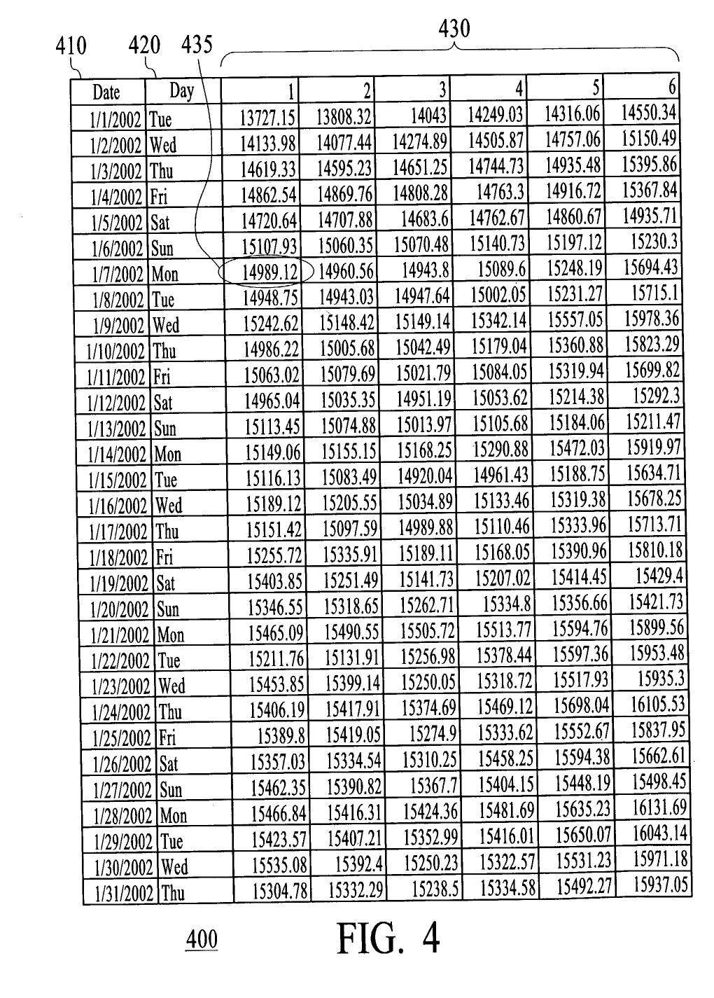

The following is a more detailed description of the method in accordance with an embodiment of the present invention. The process begins with the compilation of energy consumption data in mega watts (MW) per time period (typically hours) over a duration thereby yielding a profile. In embodiment, energy consumption data is compiled via a data matrix. FIG. 4 shows an example of a data matrix 400 in accordance with an embodiment of the present invention. The data matrix 400 encompasses the amount of energy consumed during a predetermined duration and time. It should be understood that the predetermined duration could be any of a variety of durations as well as periods of time. For example, the data could be compiled monthly, quarterly, bi-annually, annually, etc. while remaining within the spirit and scope of the present invention.

In this case, the predetermined duration of time is the month of January 2002 for the period of time of hours 1-6 (12AM -6AM) of each day. Accordingly, the data matrix 400 includes a date column 410, a day-of-the-week column 420, and hour columns 430. Each data entry represents the amount of energy consumed for that particular hour of that particular day. For example, item 435 of FIG. 4 represents the amount of energy consumed between 12AM and 1AM on Monday Jan. 7, 2002. As shown, the amount of energy is 14989.12 MW.

In an embodiment, separate data matrices are compiled representative of data consumption for “off peak” hours and “peak” hours. Off peak hours are generally designated as hours where energy consumption is minimal (hours 1-6, 23-24). The remaining hours (7-22) are considered peak hours i.e. energy consumption is relatively high. It should be understood by one of ordinary skill in the art that the described process of this patent application can be implemented based on off-peak data consumption and/or peak data consumption while remaining within the spirit and scope of the present invention.

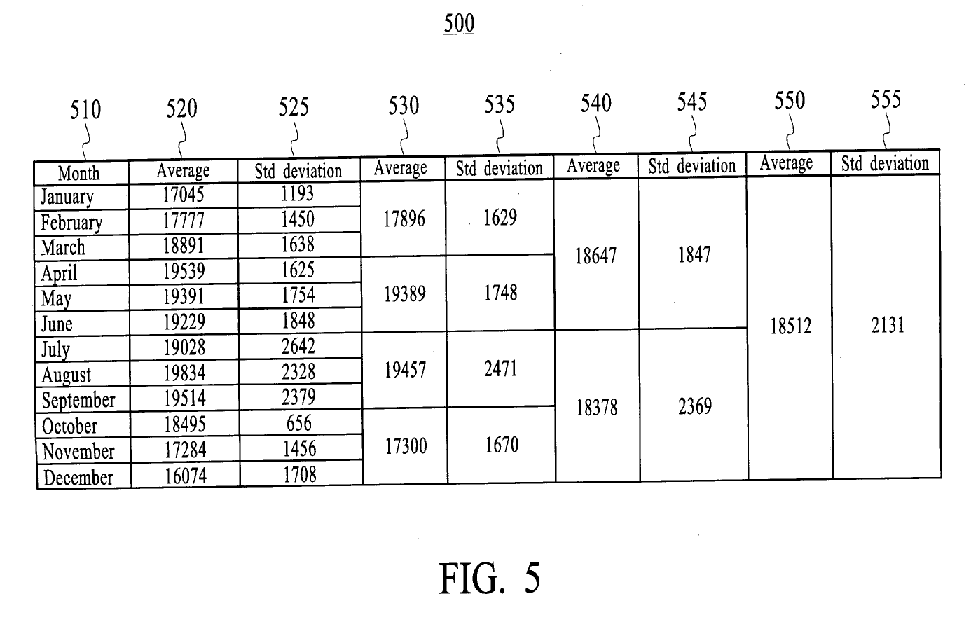

Next, the mean and standard deviation are calculated for the predetermined periods. FIG. 5 shows a graphical display of a mean/standard deviation table 500. The mean/standard deviation table includes a month column 510. The table also includes first, second, third and fourth mean columns 520, 530, 540, 550 as well as first, second, third and fourth standard deviation columns 525, 535, 545, 555. First mean column 520 is associated with the first standard deviation column 525, second mean column 530 is associated with the second standard deviation column 535, etc.

The first mean column 520 tabulates mean values on a monthly basis i.e. one mean value per month. The second mean column 530 tabulates mean values on a quarterly basis, i.e. one mean value per every three months. The third mean column 540 tabulates mean values on a bi-annual basis i.e. one mean value per every six months and the fourth mean value column 550 tabulates mean values on a yearly basis.

Next, in order to begin the calculation of risk components for an associated boundary of potential volume values of energy, an initial volume is established. In an embodiment, the initial volume is based on the following relationship:

Vᵢₙₜ=2(Std Dev)+Ave

where Vᵢₙₜ is the initial volume, Std Dev is the standard deviation and Ave is the mean value. For example, applying this formula to mean column 530 for the first quarter (January-March):

Vᵢₙₜ=2(1629)+17896=21154

Therefore, the initial volume is 21154 W or 21.15 MW.

Once the initial volume is established, a 1 tail positive statistic is calculated and displayed based on the standard normal Z-distribution. The 1 tail positive statistic, Tₚₒₛ, is calculated based on the following relationship:

Tₚₒₛ=1−T_{neg}

where T_{neg} is a 1 tail negative statistic and is the result of taking the z score formula:

Z=((X−μ)÷σ)

and using the function:

ℑ(Z;0,1)=(1÷(SQRT(2Π))e^{-(Z1÷2)}

in place of the table of standard normal curves areas, to calculate the probability of obtaining a figure less than a particular value.

Accordingly, Tₚₒₛ is a risk component that represents the probability that the associated volume will be more than what is needed for the particular period in question.

Next, a plurality of Tₚₒₛ values are iteratively calculated for subsequent volume values. In an embodiment, subsequent volume values are generated by subtracting 0.25 from the previous volume value. For example, if the initial volume, Vᵢₙₜ is 21.15, the next volume value is 20.90, the next volume value is 20.65, etc. Accordingly, a Tₚₒₛ values is generated for each subsequent volume value. In an embodiment, 8 Tₚₒₛ values are calculated and displayed in a tabulated fashion, thereby establishing a boundary of probable volume values and associated risk components.

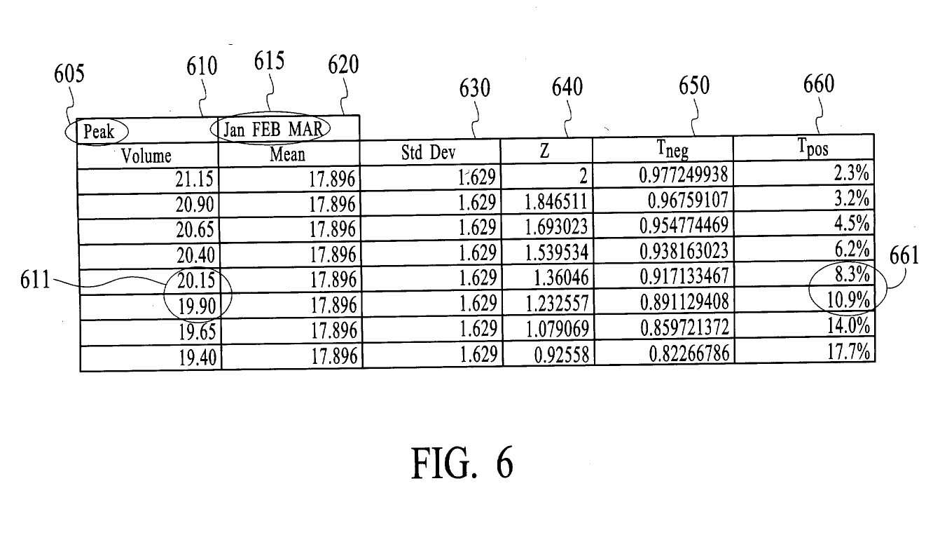

Please refer now to FIG. 6. FIG. 6 shows a risk table 600 in accordance with an embodiment of the present invention. Risk table 600 includes a volume column 610, a mean column 620, a standard deviation column 630, a Z column 640, a T_{neg} column 650 and a Tₚₒₛ column 660. The risk table 600 also includes a designator section 605, which designates whether the risk table 600 is associated with peak or off-peak values and a period section 615 that indicates which period is being analyzed.

The Tₚₒₛ column 660 tabulates risk components that are associated with the volume values in volume column 610. In an embodiment, a risk component is the probability that the associated volume of energy will be more than what will be needed for the period in question and can be equated to the exposure risk of the open market. For example, if a facility manager wants to block purchase 20 MW of peak energy at a specific price for a quarter, what is the probability that the energy needs will exceed 20 MW in any particular time period over a certain duration? A quick look at the risk table 600 will reveal this needed information. Looking in the volume column 610, 20 MW is between volumes 20.15 and 19.90 (item 611). Accordingly, the corresponding risk components are 8.3% and 10.9% (item 661) respectively. Consequently, the probability that the energy needs will exceed 20 MW is between 8.3% and 10.9%. Therefore, based on the risk that the facility manager is willing to take, she can block purchase a desired volume of energy at a rate that is substantially cheaper than the full requirement rate.

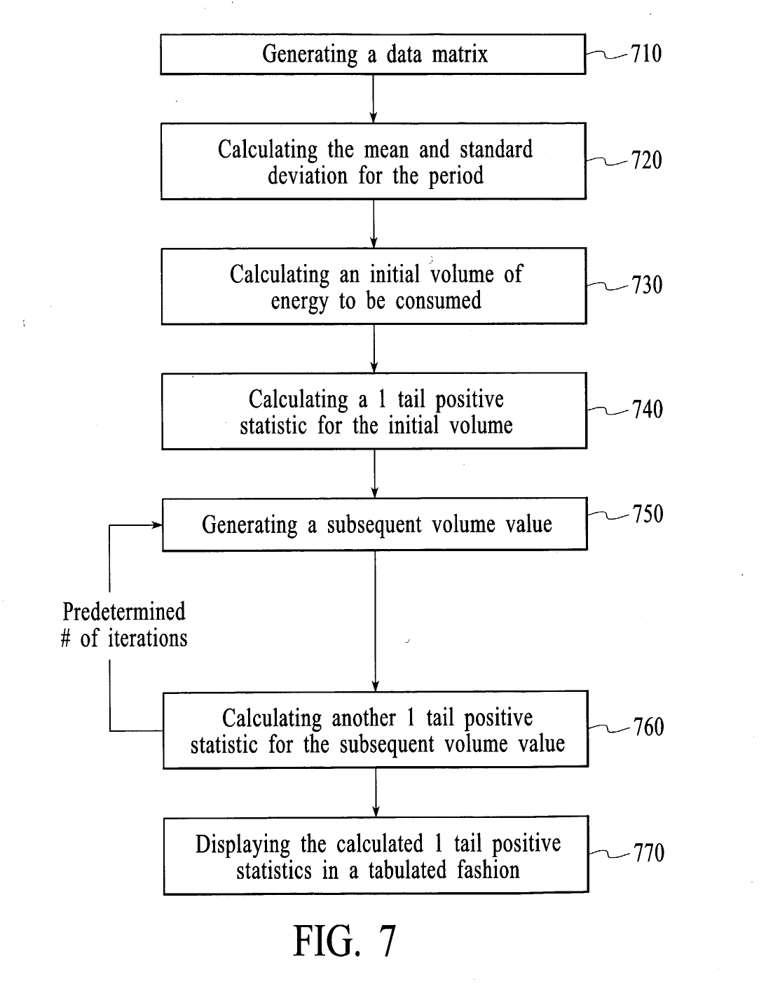

FIG. 7 is a more detailed flowchart of a method in accordance with an embodiment of the present invention. A first step 710 includes generating a data matrix. In various embodiments, the data matrix could contain off peak data or peak data. A second step 720 includes calculating the mean and standard deviation of the period. A third step 730 includes calculating an initial volume of energy to be consumed. A fourth step 740 involves calculating a 1 tail positive statistic for the initial volume. In an embodiment, the 1 tail positive statistic is the risk component for the associated volume.

A fifth step 750 includes generating a subsequent volume value. In an embodiment, this step involves subtracting 0.25 from the initial volume. A sixth step 760 includes calculating another 1 tail positive statistic for the subsequent volume value. Steps 750 and 760 are then repeated for a predetermined number of iterations. A final step 770 includes displaying the calculated 1 tail positive statistics in a tabulated fashion.

A method and system for calculating risk components associated with the consumption of an indirect procurement commodity is disclosed. The present invention calculates risk components associated with a block purchase of the indirect procurement commodity by statistically analyzing a history of consumption of the indirect procurement commodity. Consequently, based on the amount of risk a user is a system user willing to take, a substantial reduction in the costs associated with the purchase of indirect procurement commodities can be achieved.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for calculating risk components associated with the consumption of an indirect procurement commodity comprising:
receiving consumption data related to an indirect procurement commodity;
establishing a volume of the indirect procurement commodity to be consumed during a future predetermined duration and time period based on the consumption data; and
calculating at least one risk component wherein the at least one risk component is associated with the volume of the indirect procurement commodity to be consumed during a future predetermined period.

2. The method of claim 1 wherein the indirect procurement commodity comprises energy.

3. The method of claim 1 wherein the consumption data is received via an Excel based tool via a graphical user interface.

4. The method of claim 3 wherein the consumption data includes a data matrix.

5. The method of claim 4 wherein establishing a volume of the indirect procurement commodity to be consumed during a future predetermined period based on the consumption data comprises establishing a boundary of probable volume values.

6. The method of claim 5 wherein establishing a boundary of probable volume values comprises:
calculating a mean and standard deviation of the data matrix; and
adding two standard deviations to the mean thereby establishing a starting point of the boundary of probable volume values.

7. The method of claim 6 wherein calculating the at least one risk component further comprises:
a calculating a one-tail positive statistic associated with the volume.

8. The method of claim 7 further comprising completing an iteration wherein the iteration comprises:
establishing another volume; and
calculating another one-tail positive statistic for the another volume.

9. The method of claim 8 wherein establishing another volume comprises subtracting 0.25 from the volume.

10. The method of claim 8 wherein the data matrix is at least one of an off-peak data matrix and a peak data matrix.

11. The method of claim 8 wherein the at least one risk component is calculated for a predetermined period.

12. The method of claim 11 wherein the predetermined period is at least one of 1 month, 3 months, 6 months and 12 months.

13. A system for calculating risk components associated with the consumption of an indirect procurement commodity comprising:
a graphical user interface; and
a risk calculation tool coupled to the graphical user interface capable of:
receiving consumption data related to an indirect procurement commodity;
establishing a volume of the indirect procurement commodity to be consumed during a future predetermined period based on the consumption data; and
calculating at least one risk component wherein the at least one risk component is associated with the volume of the indirect procurement commodity to be consumed during the future predetermined period.

14. The system of claim 13 wherein the indirect procurement commodity comprises energy.

15. The system of claim 13 wherein the risk calculation tool comprises an Excel based tool and receiving the consumption data comprises receiving the consumption data into the Excel based tool via the graphical user interface.

16. The system of claim 15 wherein the consumption data includes a data matrix.

17. The system of claim 16 wherein establishing a volume of the indirect procurement commodity to be consumed during a future predetermined period based on the consumption data comprises establishing a boundary of probable volume values.

18. The system of claim 17 wherein establishing a boundary of probable volume values comprises:
calculating a mean and standard deviation of the data matrix; and
adding two standard deviations to the mean thereby establishing a starting point of the boundary of probable volume values.

19. The system of claim 18 wherein calculating the at least one risk component further comprises:
calculating a one-tail positive statistic associated with the volume.

20. The system of claim 19 further comprising completing an iteration wherein the iteration comprises:
establishing another volume; and
calculating another one-tail positive statistic for the another volume.

21. The system of claim 20 wherein establishing another volume comprises subtracting 0.25 from the volume.

22. The system of claim 20 the data matrix is at least one of an off-peak data matrix and a peak data matrix.

23. The system of claim 20 wherein the at least one risk component is calculated for a predetermined period.

24. The system of claim 23 wherein the predetermined period is at least one of 1 month, 3 months, 6 months and 12 months.

25. A computer program product for calculating risk components associated with the consumption of an indirect procurement commodity, the computer program product comprising a computer usable medium having computer readable program means for causing a computer to perform the steps of:
receiving consumption data related to an indirect procurement commodity;
establishing a volume of the indirect procurement commodity to be consumed during a future predetermined period based on the consumption data; and
calculating at least one risk component wherein the at least one risk component is associated with the volume of the indirect procurement commodity to be consumed during a future predetermined period.

26. The computer program product of claim 25 wherein the consumption data includes a data matrix.

27. The computer program product of claim 26 wherein establishing a volume of the indirect procurement commodity to be consumed during a future predetermined period based on the consumption data comprises establishing a boundary of probable volume values.

28. A method of doing business comprising:
receiving consumption data related to an indirect procurement commodity;
establishing a volume of the indirect procurement commodity to be consumed during a future predetermined duration and time period based on the consumption data; and
calculating at least one risk component wherein the at least one risk component is associated with the volume of the indirect procurement commodity to be consumed during a future predetermined period.

29. The method of claim 28 wherein the indirect procurement commodity comprises energy.

30. The method of claim 28 wherein the consumption data is received via an Excel based tool via a graphical user interface.

31. The method of claim 30 wherein the consumption data includes a data matrix.

32. The method of claim 31 wherein establishing a volume of the indirect procurement commodity to be consumed during a future predetermined period based on the consumption data comprises establishing a boundary of probable volume values.

33. The method of claim 32 wherein establishing a boundary of probable volume values comprises:
a calculating a mean and standard deviation of the data matrix; and
adding two standard deviations to the mean thereby establishing a starting point of the boundary of probable volume values.
